(19) United States
(12) Patent Application Publication
(10) Pub. No.: US 2023/0399709 A1
(43) Pub. Date: Dec. 14, 2023

(54) IMPROVEMENTS IN OR IN RELATION TO THE PREPARATION AND DELIVERY OF SUGAR CANE TO A SUGAR MILL

(71) Applicant: Alan Lewis Fitzmaurice, Brisbane (AU)

(72) Inventor: Alan Lewis Fitzmaurice, Brisbane (AU)

(21) Appl. No.: 18/033,537

(22) PCT Filed: Oct. 28, 2021
(86) PCT No.: PCT/AU2021/051258

§ 371 Date: Apr. 24, 2023

(30) Foreign Application Priority Data
Oct. 28, 2020 (AU) 2020903901

(51) Int. Cl. C13B 5/04; B02C 18/22; B02C 18/10; B02C 25/00

(52) U.S. Cl. CPC C13B 5/04; B02C 18/2241; B02C 18/2291; B02C 18/10; B02C 25/00

(57) ABSTRACT

A cane shredder input is optimized for any given load condition comprising a feeder upstream of the shredder to controllably deliver cane downstream from the feeder in order to reduce shredder drive load fluctuations. A “kicker” (26) with curved end knives gives full coverage across the width of the cane carrier, and is driven clockwise at about 175 rpm. A magnetic shredder and milling tandem protector pulls metal out of the cane above a backward inclined chute (27). The chute has a viewing window (28) and a cane height sensor (29). The backward directed chute aids in cane striking its front wall (30) and the working face of the chute height control device. A tooth feeder shredder rotor (31) is located in a shredder housing (32). The shredder housing (32) is a convolute in configuration. Sitting directly atop the shredder housing (32) is a tooth feeder (33), in this case having tooth feeder wheels (34) and (35). The feeder operates as a speed baffle to the shredder so that cane is delivered at an optimal rate. The throughput through the factory is based on the speed of the feeder.

### TECHNICAL FIELD

THIS INVENTION relates to improvements in or in relation to the preparation and delivery of sugar cane in or to a sugar mill and in particular but not limited to preparation and delivery of sugar cane to a milling tandem.

### BACKGROUND

Conventional cane factories usually employ cutters and shredders upstream of the mills. Conventional sugar mills regulate operation of the mills in accordance with the amount of cane being processed at any point in time. It is usual to employ an input height sensor to control the height of shredded cane in a vertical hopper above a first (squeezing) mill to deliver shredded cane at a rate depending on the set throughput rate of the first mill. Therefore, the throughput of this mill controls the milling rate of the factory.

The normal cane preparation system is as follows—
A cane carrier, or carriers have either a vertical type shredder or a horizontal type shredder installed at the delivery end of the last cane carrier.
The cane carrier/s may have one or more sets of knives to chop full stalk cane into smaller pieces. However, knives are not necessary for processing 100% mechanically harvested cane.
A conveyor after the shredder, delivers shredded cane to the first (squeezing) mill.
If this conveyor is a belt type conveyor, there is normally a magnet over this conveyor to collect any metal parts that have gone through the shredder, so these parts do not feed into the mills in the tandem, causing various degrees of damage. These metal parts generally come to the factory with delivered cane. However, the shredder is not protected, and the shredder is the machine most vulnerable to damage by ingress of “tramp iron”.
There is normally a vertical hopper to feed the first mill with a constant supply of shredded cane.
Normally there is an installed system to “sense” the height of shredded cane in the vertical hopper above the first mill and send a signal to the cane carrer speed control dependent on the height of shredded cane in the vertical hopper.
Normally the first mill's speed is set at a fixed speed to control the daily milling rate for processing cane.
When the level of shredded cane is low in the vertical hopper, the output signal from the chute height sensor “tells” the cane carrier/s to increase speed to bring the level of shredded cane up to a specified level.
Conversely, if the height of shredded cane in the vertical hopper is high, the output signal slows the speed of the cane carrier/s.
With this “normal” type control the cane tonnage passing through the shredder varies considerably, so the load on the shredded drive is also varying from low to maximum power. Some consequences of this include, affecting the operation of boiler/s if the large shredder drive is a steam turbine, or to the operation of the powerhouse and boiler/s if the shredder drive is a large electric motor.
With shredder installations the high-speed spinning rotor and hammers works like a large fan, sucking air into the shredder then blowing it out with the flow of shredded cane.
“Windage” from normal shredder installations can be a problem as the flow of air from the shredder has lots of very fine juice droplets that cover everything in the vicinity of the shredder. As well as high pol juice droplets, there may also be fine particles of cane fibre. This outflow of sticky juice plus fibre creates a constant mess that has to be cleaned from time to time.
For vertical feed shredders, cane falls from the end of the cane carrier, into the shredder. The falling speed of the chopped cane pieces can be quite high. So, the hitting speed of the hammers on these cane pieces is reduced by the falling speed of the cane pieces, reducing the degree of cane preparation.

### OUTLINE

As a consequence of the above it is an object of the present invention to improve cane preparation and reduce shredder drive load fluctuations, by controlling delivery of cane to the shredder. In one preferred form and application there is provided a cane shredder input optimized for any given load condition comprising a feeder upstream of the shredder to controllably deliver cane downstream from the feeder in order to reduce shredder drive load fluctuations. Thus in a sugar cane factory having a controlled throughput, the throughput may be controlled in concert with the speed of a variable speed input feeder, the speed of the input feeder being automatically adjusted in response to cane load to the input feeder. The feeder may be a tooth feeder. In cases that usually employ control to the first squeezing mill the invention is an alternative, rather than to the first (squeezing) mill. In one preferred aspect there is method, therefore there is provided a method of cane preparation for a sugar cane factory involving a shredder, a hopper or chute upstream of the shredder and a feeder between the chute and shredder, the method comprising:—
(a) Supplying sufficient cane to the hopper/chute to choke feed the feeder; and
(b) Operating the feeder at a predetermined speed to deliver cane to the shredder and corresponding to a set required milling rate for the factory operation.

Preferably, the method further employs a cane sensor influenced by the cane in the hopper/chute, the method further comprises operating a cane carrier upstream of the hopper/chute to increase or decrease cane delivery to the hopper in response to the cane sensor.

Preferably, the shredder is upstream of a first mill and the method further comprises the operation of the first mill substantially in concert with the feeder. Typically, the throughput from the mill is the same as the feeder, preferably, a tooth feeder. Therefore, typically there is a chute height control and the chute height control is in the first mill's vertical hopper, with the intervention of the feeder, this now controls the speed of the first mill to maintain a constant height of shredded cane in the vertical hopper, similar to controls for the other mills in the tandem. In a preferred form, the speed of the first mill no longer controls the daily milling rate.

In another aspect the feeder, preferably, a tooth feeder, is located at the entrance to or on top of the shredder and delivers the cane to the shredder at a constant required daily milling rate. Thus the tooth feeder functions as a speed baffle to slow cane entry into the shredder, as well as a meter for cane rate into the shredder. This leads to a further preferred step in the method, namely, using cane to rescue airflow and reduction or inhibition of windage, thus the feeder exit and shredder entrance are so made and arranged that cane fills the entrance to the shredder, and “windage” is inhibited.

In a further aspect of the method cane leaving the carrer falls or is flung against a front wall of the chute. To this end the chute may have a front face which may be inclined in order to represent the front face. The carrier may comprise an elevator having a direction of travel and lifting cane to a raised position above a chute entrance, the chute sloping backward in opposition to the direction of travel. There are two reasons for sloping the chute.
1. Better control of the chute height control mounted on the front face of the vertical hopper.
2. Allows an extra grid to be mounted on an anvil bar for better cane preparation.

However, the vertical chute may be a hopper which can be vertical with the chute height monitored on the side of the hopper, or sloping outward with the chute height control on the side or back of the hopper.

Preferably, the chute/hopper employs a magnetic separator with the chute/hopper being dimensioned and arranged such that it creates a thin flow of cane across magnets, preferably located at the front of the chute/hopper. The presence of the tooth feeder permits this flow to be managed. Unlike all other cane preparation systems in use to date, in a preferred form, the present invention protects the very vulnerable shredder rotor, hammers and very hard wear resistant hammer tips, plus the hardened anvil bar grids from damage from “tramp iron” (introduced metal objects) feeding in with the cane supply. The chopped cane flowing over the face of the magnet is a very thin layer, the collection efficiency of the magnet is therefore very high. Due to the volume of chopped cane in the vertical hopper and the intervention of the tooth feeder, the factory does not lose time removing the “tramp iron” from the magnetic separator.

### BRIEF DESCRIPTION OF THE DRAWINGS

In order that the present improvements may be more readily understood and put into practical effect reference will now be made to the accompanying drawings which illustrate preferred embodiments of the invention and wherein:—

FIG. 1 is a block diagram showing the key elements of a preferred form of the present invention;

FIG. 2 is a simplified flow diagram of the present invention and its method;

FIG. 3 is a schematic showing a cane carrier, a chute, a feeder and shredder arrangement;

FIG. 4 is a more detailed drawing of the end of the carrier, the chute feeder and shredder; and

FIG. 5 is a more detailed view of a typical feeder.

### METHOD OF PERFORMANCE

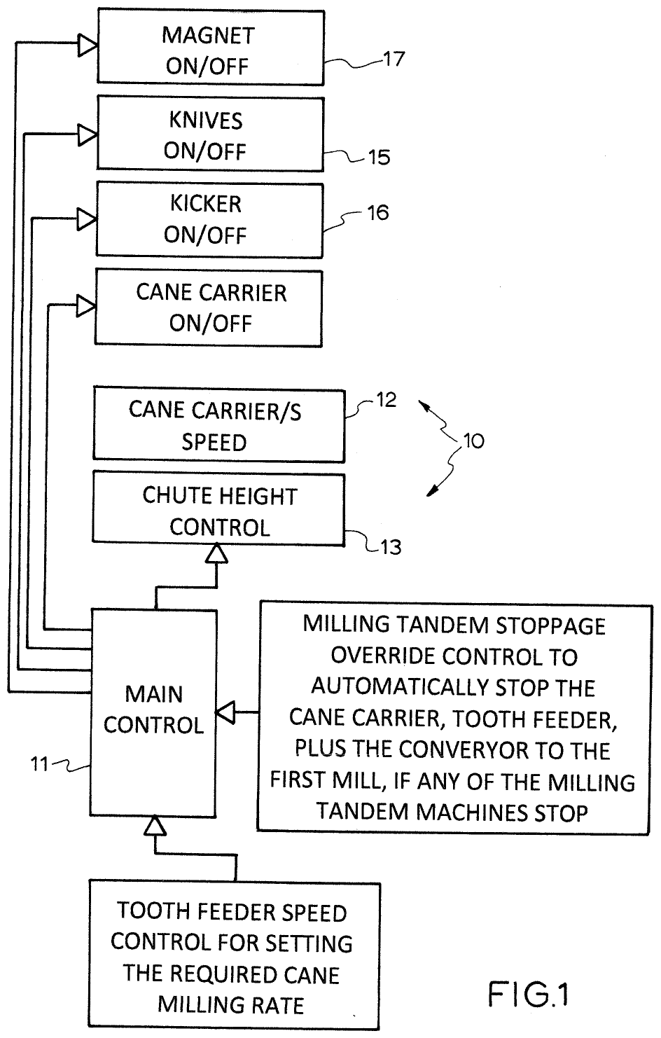

Referring to the drawings and initially to FIG. 1 there is illustrated the control elements 10 of a system for cane preparation and flow of the cane to a first mill (not shown). The first mill will usually be the first mill in a milling tandem. Of course there are other elements vital to the overall operation of a sugar cane factory but these have been omitted as the present invention only concerns the initial stages. It will, however, be appreciated, that this initial preparation has an overall effect on outcome, efficiency and operation, including a reduction in the frequency of having to clean the shredder surrounds.

There is a main control 11, this has overall control of the factory milling tandem but as is relevant here controls a cane carrier operating speed, via a cane carrer drive control 12, a cane hopper height sensor, via a height sensor control 13, and a toothed feeder via a toothed feeder speed control 14 that sets the factory cane milling rate. The cane knive/s, kicker and magnet have on/off operating start/stop switches at 15, 16 and 17.

The arrows between the blocks indicate possible dependencies, for example, the main control sets the setpoint for the level of chopped cane in the vertical hopper above the tooth feeder. The height of chopped cane in the vertical hopper above the tooth feeder controls the operating speed of the cane carrier. High level slows the speed of the cane carrier. Low level increases the speed of the cane carrier. There needs to be an override signal from the machines in the milling tandem after the shredder that stops the cane carrier, the tooth feeder and the conveyor in front of the first mill, should any of the downstream milling tandem machinery suddenly stop.

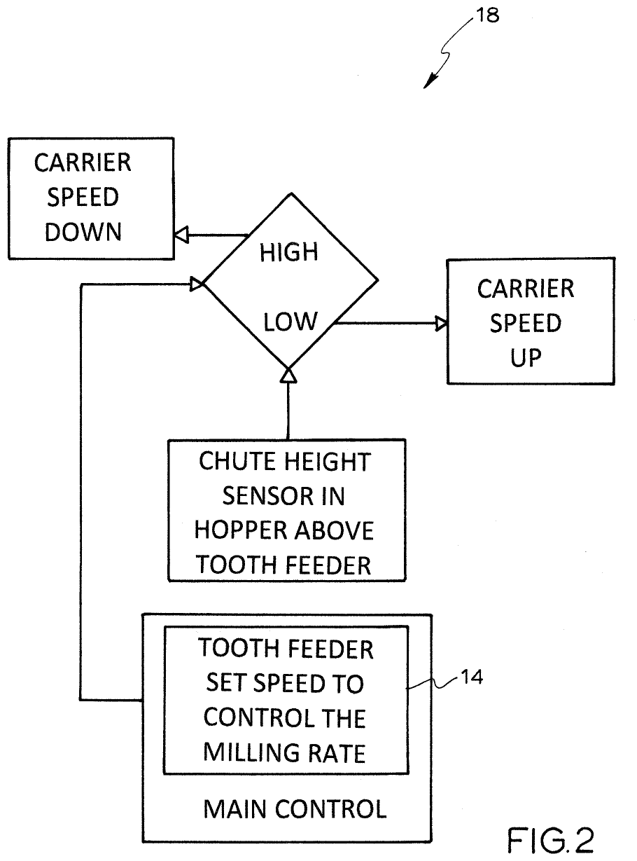

This relationship between the height control, toothed feeder and the cane carrier/s is illustrated at 18 in the “simplified” flow chart of FIG. 2.

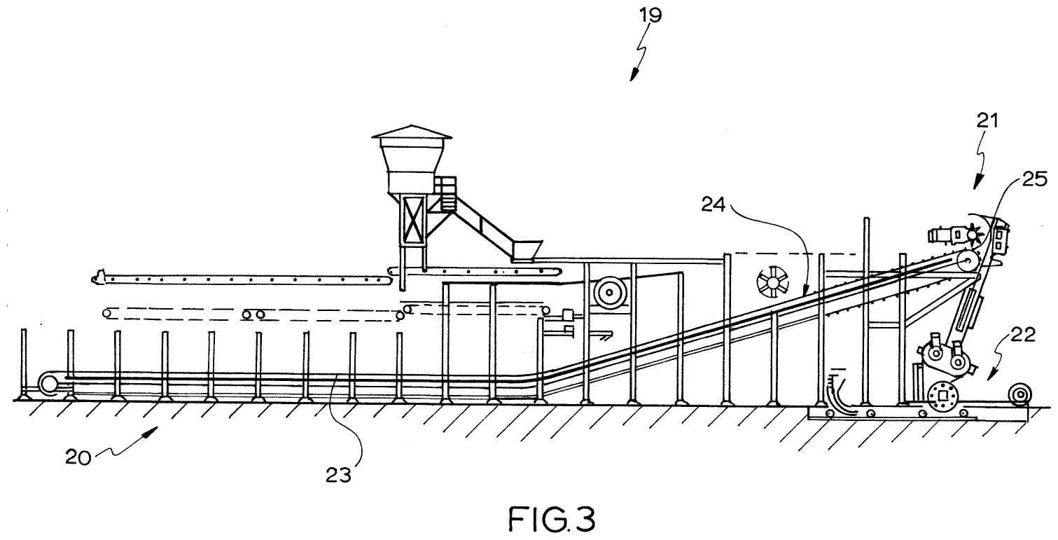

Referring to FIG. 3 there is illustrated a part 19 of a sugar cane factory, comprising an input cane carrier 20, a chute, shredder feeder and shredder assembly 21 which outputs shredded cane on to a maceration elevator (not shown) at 22 and which in turn delivers the shredded cane to a first mill (not shown). This would usually be the first mill of a milling tandem.

The cane carrier has a conveyor 23 with an elevator section 24. The cane (not shown) leaving the cane carrier 25 is in a chopped or billeted form.

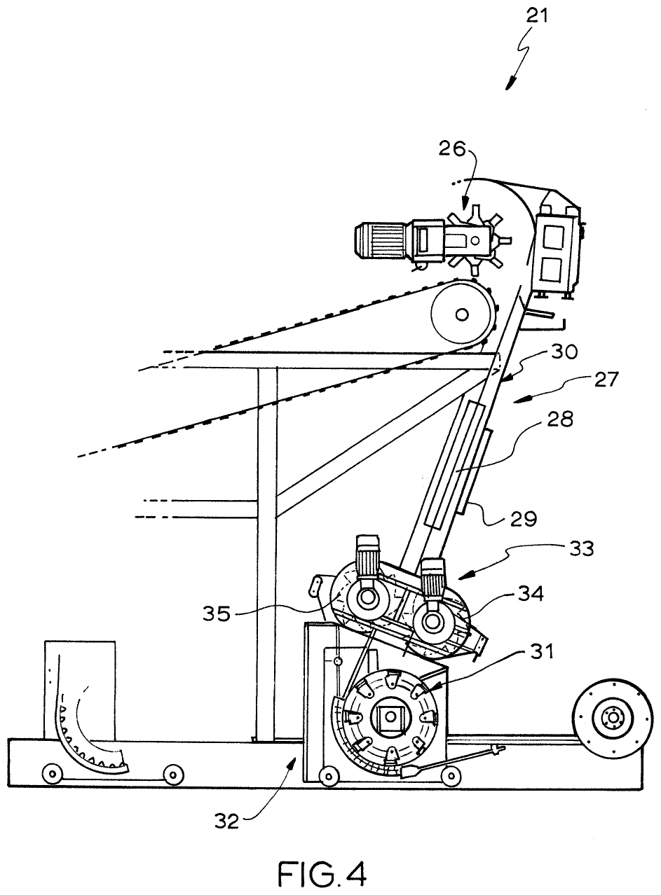

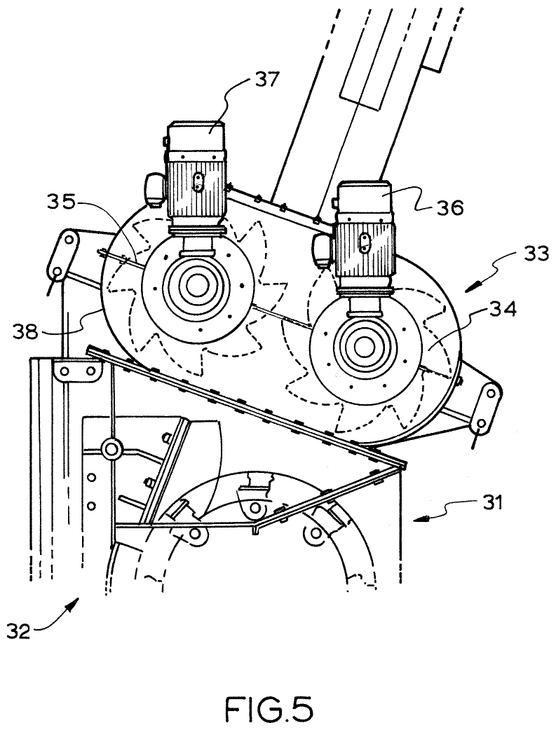

Referring now to FIG. 4 the assembly 21 will be described in some detail. A “kicker” 26 with curved end knives to give full coverage across the width of the cane carrier, is driven clockwise at about 175 rpm. A magnetic shredder and milling tandem protector pulls metal out of the cane above a backward inclined chute 27. The chute has a viewing window 28 and a cane height sensor 29. The backward directed chute aids in cane striking its front wall 30 and the working face of the chute height control device. A tooth feeder shredder rotor 31 is located in a shredder housing 32. The shredder housing 32 is a convolute in configuration. Sitting directly atop the shredder housing 32 is a tooth feeder 33, in this case having tooth feeder wheels 34 and 35. The shredder/tooth feeder combination is shown in more detail in FIG. 5.

The shredder/tooth feeder wheels 34 and 35 are driven in contrarotation with wheel 35 driven clockwise, the wheels are driven by gear sets (not shown) using shaft mounted gear motors 36 and 37 for drives. The wheels are inside a close fitting housing 38 and have teeth or ribs 39 acting in the direction of rotation to move cane outwardly from centre and back to centre. Thus it operates both as a feed baffle to interrupt the drop velocity of cane to the shredder, but also actively metering cane to the shredder at a constant rate, thus providing a constant flow at practically a very low velocity to maximize shredding performance.

The first mill set speed is no longer in control of the factory's milling rate, and its speed is now controlled by the height of bagasse in the vertical hopper. High level, faster mill speed. Low level, slower mill speed. Thus it will be appreciated that the load on the shredder is maintained constant and the speed of cane delivery to the shredder by reason of the outlet from the tooth feeder being directly above the shredder housing and connected on to the shredder housing. This means that cane is entering the shredder at an optimal slow speed to maximize the shredder hammer hitting speed and improve the shredding performance of the shredder. It will be further appreciated that the position of the feeder and it being over the entrance to the shredder and being choke fed that windage is practically eliminated by the cane in the feeder.

Whilst the above has been given by way of illustrative example many variations and modifications will be apparent to those skilled in the art without departing from the broad ambit and scope of the invention as herein set out in the appended claims.

What is claimed is:

1. A cane shredder input optimized for any given load condition comprising a feeder upstream of the shredder to controllably deliver cane downstream from the feeder in order to reduce shredder drive load fluctuations.

2. The cane shredder input according to claim 1 employed in a method of cane preparation for a sugar cane factory involving a shredder, a hopper or chute upstream of the shredder and a feeder between the chute and shredder, the method comprising:—
(a) Supplying sufficient cane to the hopper/chute to choke feed the feeder; and
(b) Operating the feeder at a predetermined speed to deliver cane to the shredder and corresponding to a set required milling rate for the factory operation.

3. The method of claim 2 further comprising a cane sensor influenced by the cane in the hopper/chute, the method further comprises operating a cane carrier upstream of the hopper/chute to increase or decrease cane delivery to the hopper in response to the cane sensor.

4. The method of claim 2 further comprising communicating a cane load pressure signal from downstream to a cane carrier to increase or decrease delivery of cane by the cane carrier.

5. The method of claim 2 wherein the shredder is upstream of a first mill and the method further comprises the operation of the first mill substantially in concert with the feeder.

6. The method of claim 2 wherein the shredder is upstream of a first mill, the first mill having a vertical hopper and chute and there being a chute cane height control and the chute cane height control is in the first mill's vertical hopper, with the intervention of the feeder, the feeder controls the speed of the first mill to maintain a constant height of shredded cane in the vertical hopper.

7. The method according to claim 2 wherein the feeder is located at an entrance to or on top of the shredder and delivers the cane to the shredder at a constant required daily milling rate.

8. The method according to claim 2 wherein the feeder functions as a speed baffle to slow cane entry into the shredder, as well as a meter for cane rate into the shredder.

9. The method according to claim 2 wherein the feeder functions as a speed baffle to slow cane entry into the shredder, as well as a meter for cane rate into the shredder, a further step in the method, namely, using cane to rescue airflow and reduction or inhibition of windage, thus the feeder exit and shredder entrance are so made and arranged that, cane fills the entrance to the shredder, and “windage” is inhibited.

10. The method according to claim 2 wherein a carrier is upstream of a chute, the cane leaving the carrier falls or is flung against a front wall of the chute.

11. The method according to claim 2 wherein a carrier is upstream of a chute, the cane leaving the carrier falls or is flung against a front wall of the chute, the front wall sloping backward in opposition to the direction of travel of cane from the carrier.

12. The method according to claim 2 wherein a carrier is upstream of a chute, the cane leaving the carrier falls or is flung against a front wall of the chute, the front wall sloping backward in opposition to the direction of travel of cane from the carrier which comprises an elevator having a direction of cane travel and lifting cane to a raised position above a chute entrance, the chute sloping backward in opposition to the direction of cane travel.

13. The method according to claim 2 wherein a carrier is upstream of a chute, the cane leaving the carrier falls or is flung against a front wall of the chute, the front wall sloping backward in opposition to the direction of travel of cane from the carrier which comprises an elevator having a direction of cane travel and lifting cane to a raised position above a chute entrance, the chute sloping backward in opposition to the direction of cane travel.

14. The method according to claim 2 wherein a vertical chute may be part of or a hopper which can with the height of cane in the chute height monitored on the side of the hopper, or sloping outward with the chute height control on the side or back of the hopper.

15. The method according to claim 2 wherein the chute/hopper employs a magnetic separator with the chute/hopper being dimensioned and arranged such that it creates a thin flow of cane across magnets, the feeder being downstream and its operation effectively managing the flow across the magnets.

16. The method according to claim 2 wherein the feeder is a tooth feeder.

17. A sugar cane factory having a controlled throughput, the throughput being controlled in concert with the speed of a variable speed input feeder, the speed of the input feeder being automatically adjusted in response to cane load to the input feeder.

18. A sugar cane factory according to claim 17 wherein a magnetic separator with the chute/hopper being dimensioned and arranged such that it creates a thin flow of cane across magnets, the feeder being downstream and its operation effectively managing the flow across the magnets.

19. A sugar cane factory according to claim 18 wherein the feeder is a tooth feeder.

20. A sugar cane factory according to claim 19 wherein the tooth feeder has tooth feeder wheels driven in contrarotation, the wheels being inside a close fitting housing and having teeth or ribs acting in the wheel's direction of rotation to move cane outwardly from centre and back to centre.

21. A sugar cane factory according to claim 19 wherein the tooth feeder has tooth feeder wheels driven in contrarotation, the wheels being inside a close fitting housing and having teeth or ribs acting in the wheel's direction of rotation to move cane outwardly from centre and back to centre thus the feeder operates both as a feed baffle to interrupt the drop velocity of cane to the shredder, but also actively metering cane to the shredder at a constant rate, thus providing a constant flow at practically a very low velocity to maximize shredding performance.
